(19) United States
(12) Patent Application Publication
(10) Pub. No.: US 2023/0106091 A1
(43) Pub. Date: Apr. 6, 2023

(54) CENTRALIZED APPLICATION PROGRAMMING INTERFACE (API) BROKER FOR PROVIDING SERVICES OFFERED BY MULTIPLE SERVICE PLATFORMS

(71) Applicant: Hewlett Packard Enterprise Development LP, Houston, TX (US)

(72) Inventor: Lokesh Shivashankara, Bangalore Karnataka (IN)

(21) Appl. No.: 17/644,552

(22) Filed: Dec. 15, 2021

(30) Foreign Application Priority Data
Oct. 1, 2021 (IN) 202141044832

(51) Int. Cl. G06F 9/54

(52) U.S. Cl. CPC G06F 9/547; G06F 9/541

(57) ABSTRACT

Examples described herein relate to a centralized API broker for providing services offered by service platforms to users of the cloud platform. The centralized API broker registers multiple service platforms and converts native APIs supported by the service platform to APIs supported by the cloud platform and displays the APIs as catalog items in a service catalog. On selection of a catalog item, the centralized API broker receives a first operation request that is compliant with a first API specification supported by the cloud platform. The centralized API broker converts the first operation request into a second operation request that is compliant with a second API specification supported by the service platform using vendor-specific mapping. The centralized API broker makes an API call to the service platform using the second operation request.

### BACKGROUND

Cloud computing is a model of service delivery for enabling on-demand network access to a shared pool of configurable computing resources that can be rapidly provisioned and released with minimal management effort or interaction with a provider of the service. Cloud computing allows a consumer to obtain processing resources, such as networks, network bandwidth, servers, processing memory, storage, applications, and virtual machines in the form of cloud services. Several vendors are currently offering processing resources in the form of cloud services. The cloud services include infrastructure as a service, platform as a service, storage as a service, software as a service, business process as a service, and other services. These services use vendor-specific service request, access, and consumption models.

### BRIEF DESCRIPTION OF DRAWINGS

The following detailed description references the drawings, wherein:

FIG. 1 is an example of a network environment including a centralized API broker for providing services of multiple service platforms;

FIG. 2 illustrates an example of a block diagram depicting interaction between various elements in the network environment for providing cloud services;

FIG. 3 is a flow diagram of an example method for providing services offered by a service platform using the centralized API broker;

FIG. 4 is a flow diagram of an example method for converting the first operation request to the second operation request using the centralized API broker;

FIG. 5 is a flow diagram of an example method for providing service catalogs with catalog items at the cloud platform; and

FIG. 6 is a block diagram of a system for implementing the centralized API broker.

### DETAILED DESCRIPTION

The following detailed description refers to the accompanying drawings. Wherever possible, same reference numbers are used in the drawings and the following description to refer to the same or similar parts. It is to be expressly understood that the drawings are for the purpose of illustration and description only. While several examples are described in this document, modifications, adaptations, and other implementations are possible. Accordingly, the disclosed examples do not limit the description. The proper scope of the disclosed examples may be defined by the appended claims.

The terminology used herein is for the purpose of describing particular examples and is not intended to be limiting. As used herein, the singular forms “a,” “an,” and “the” are intended to include the plural forms as well, unless the context clearly indicates otherwise. The term “another,” as used herein, is defined as at least a second or more. The term “coupled,” as used herein, is defined as connected, whether directly without any intervening elements or indirectly with at least one intervening element, unless indicated otherwise. For example, two elements can be coupled mechanically, electrically, or communicatively linked through a communication channel, pathway, network, or system. Further, the term “and/or” as used herein refers to and encompasses any and all possible combinations of the associated listed items. As used herein, the term “includes” means includes but is not limited to, the term “including” means including but not limited to. The term “based on” means based at least in part on.

While certain implementations are shown and described herein, various changes in form and details may be made. For example, some features and/or functions that have been described in relation to one implementation and/or process can be related to other implementations. In other words, processes, features, components, and/or properties described in relation to one implementation can be useful in other implementations. Furthermore, it should be appreciated that the systems and methods described herein can include various combinations and/or sub-combinations of the components and/or features of the different implementations described.

Cloud service providers offer cloud services to users via a cloud platform. As used herein, the term “cloud service” or “service” can, for example, refer to shared pools of attributable computer system resources and/or services. Users perform various workloads by accessing cloud services provided by the cloud service providers via the cloud platform. For example, a user developing a web application may utilize a database service (i.e., a cloud service) provided by a cloud service provider for storage of contents of the web application and another service for retrieval of the content and presentation of the content on a web browser as per a service plan selected by the user. The entity responsible for the cloud platform may be the same or different from a cloud service provider, and in some cases, multiple different cloud service providers may offer cloud services to users via the cloud platform.

In some existing cloud environments, the provisioning and management of the lifecycle of the cloud service is performed by a service broker of the cloud service provider. The service broker (also referred to as a cloud service broker or cloud broker) may offer a service catalog that lists the cloud service provided by the cloud service provider. The term “service broker” can, for example, refer to an entity that manages the life cycle of services, and exposes the services offered by cloud service providers to cloud platforms. The cloud platforms interact with service brokers to provision, get access to and manage the services they offer. The cloud broker may be a software operating on an independent platform. Service brokers may be designed to support the API specification of the cloud platform. In several cases, the API may be an Open Service Broker (OSB) API, which is supported by the cloud platform. Further, each cloud service may include different service plans which represent different configuration options of service. The cloud platform exposes the service catalog from each service broker of the cloud service provider to the users of the cloud platform.

The service broker exposes the cloud service of the cloud service provider via the service catalog to the cloud platform using a service endpoint (also referred to as broker endpoint). On selection of the service plan from the service catalog, the service broker may provision a service instance to provide a requested computing resource. The provisioned instance of the service and plan is referred to as the service instance. The cloud platform connects the user of the cloud platform to the service broker via the broker endpoint to provision the service instance. Once provisioned, the service broker binds the application of the user and the service instance to provide the computing resources to the application of the user.

Any changes in the broker endpoints have to be updated in the service catalog provided by the service broker at the cloud platform. Teams at the cloud platform managing the service catalog may be assigned to manually track updates and changes in the broker endpoints provided by the service brokers of multiple cloud service providers. Managing multiple service providers and corresponding broker endpoints may not be scalable with increasing cloud service providers.

At the cloud service provider end, the cloud service provider needs to maintain the service broker to provide their services to the users of the cloud platform. The service broker provides the services provided by the cloud service provider in a format acceptable to the cloud platform. For example, a cloud service provider manually rewrites their native Application Programming Interfaces (APIs) into API formats that are acceptable to the cloud platform using the service broker and provides a broker endpoint to the cloud platform. Further, the service broker provides the service catalog with the services in the API format supported by the cloud platform. The cloud service provider maintains the multiple service brokers and corresponding broker endpoints to provide services to multiple cloud platforms. The foregoing rewriting and endpoint management requires additional manual effort that is inefficient and difficult to scale.

Therefore, in accordance with the aspects of the present disclosure, a centralized API broker is provided at the cloud platform that may overcome one or more of the problems discussed above. A centralized API broker is deployed at the cloud platform for converting the native API requests supported by service platforms into API formats that are acceptable to the cloud platform and vice-versa. In some examples, the centralized API broker provides service catalogs with the services provided by multiple service platforms in the API format supported by the cloud platform. Each service catalog associated with a service platform of a vendor provides catalog items corresponding to different operations of the service.

During operation, when a user selects a catalog item from a service catalog, a first operation request is transmitted to the centralized API broker. The first operation request is compliant with a first API specification supported by the cloud platform. In an example, the first operation request may be an (OSB) API request. The OSB API is a specification that supports different lifecycle actions for securely provisioning and using the service, with steps for service discovery, creation, and use (for example, providing information to enable connection, binding to a service, unbinding, and deletion). As described herein, the term lifecycle actions refer to different CRUD (create, read, update and delete) operations associated with the service that a user may perform using the service catalog.

On receiving the first operation request the centralized API broker converts the first operation request into a second operation request that is compliant with a second API specification supported by the service platform (i.e., the second operation request is a native API request of the service platform) using a vendor-specific command mapping between a first command specific with the first API specification and a second command specific to the second API specification supported by the service platform of the vendor. The vendor-specific command mapping is provided by the vendor to the centralized API broker while registering the service. In an example, the centralized API broker may convert an OSB API request (i.e., the first operation request) to a native API request (i.e., the second operation request). The centralized API broker makes an API call using the second operation request.

In some examples, the centralized API broker registers the services provided by the service platform of the vendor. The service platform may provide its native API using Representational State Transfer (REST) APIs associated with a lifecycle action of the service. The REST API may be compliant with the second API specification supported by the service platform. The centralized API broker includes a module that converts the REST APIs supported by a service platform of the service provider to APIs supported by the cloud platform and displays the APIs as catalog items in a service catalog to users of the cloud platform.

The registering of REST API in native format and conversion to the first API by the centralized API broker removes the role of the service broker. The vendor of the service platform does not need to create and maintain the service broker to support the first API specification of the cloud platform. The centralized API broker can register services from multiple service platforms and provide them via catalog items in service catalogs. The users of the cloud platform can communicate with the service platforms via the cloud platform (i.e., the service catalog) instead of communicating with different service brokers and their endpoints. At the cloud platform end, the use of a centralized API broker makes it easier for the teams managing the service catalog as they do not need to manage multiple service brokers of multiple service platforms.

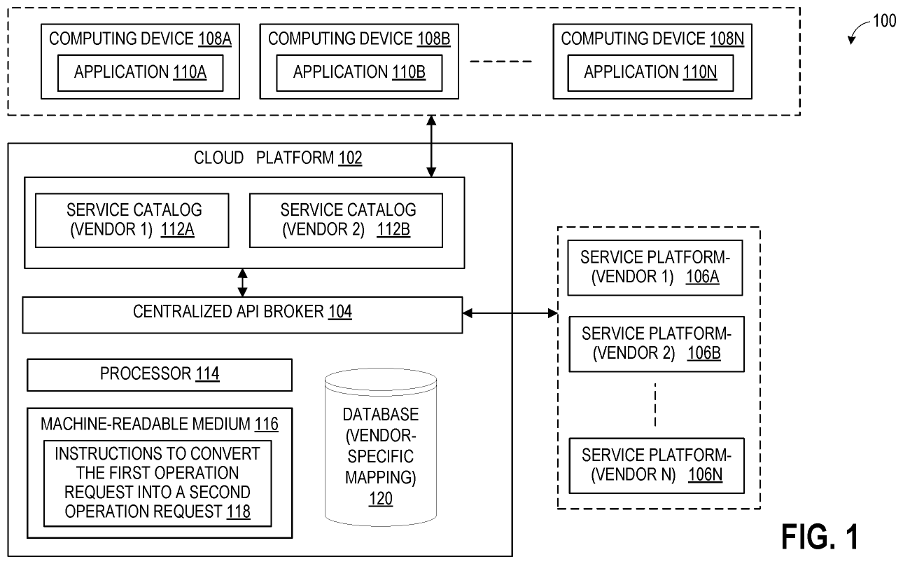

Referring now to the figures, FIG. 1 illustrates a network environment 100 including an example centralized API broker 104. The network environment 100 may include a cloud platform 102, service platforms 106A, 106B . . . 106N (hereinafter collectively referred to as 106A-106N) and computing devices 108A, 108B . . . 108N (hereinafter collectively referred to as 108A-108N) hosting applications 110A, 110B . . . 110N, (hereinafter collectively referred to as 110A-110N) respectively. The cloud platform 102 is connected to the computing devices 108A-108N and the service platforms 106A-106N over a network. The network may be a wireless or a wired network, or a combination thereof. The network may be a collection of individual networks, interconnected with each other and functioning as a single large network (e.g., the internet or an intranet). Examples of such individual networks include Global System for Mobile Communication (GSM) network, Universal Mobile Telecommunications System (UMTS) network, Personal Communications Service (PCS) network, Time Division Multiple Access (TDMA) network, Code Division Multiple Access (CDMA) network, Next Generation Network (NGN), Public Switched Telephone Network (PSTN), and Integrated Services Digital Network (ISDN). Depending on the technology, the network may include various network entities, such as transceivers, gateways, and routers.

In some examples, the cloud platform 102 may be part of a private cloud, public cloud, hybrid cloud, and/or community cloud services. As used herein, a public cloud platform can, for example, include a standard cloud computing model, in which a service provider provides a service in the form of resources, such as virtual machines (VMs), applications or storage, available to the general public over a network such as the internet. As used herein, a private cloud platform can, for example, include a model of cloud computing where Information Technology (IT) services are provisioned over private IT infrastructure for the dedicated use of a single cloud customer. A hybrid cloud platform may provide a combination of cloud services provided by the public cloud platform and cloud services provided by the private cloud platform.

In some implementations, some or all of network environment 100 may be useful for providing computing-related solutions to users as a service. For example, a user may order a computing solution to perform a desired workload via a web-based interface or portal of the cloud platform 102. The entity operating the cloud platform 102 may deliver the ordered computing solution (e.g., infrastructure having hardware and software, represented by e.g., computing devices 108A-108N) to the user's data center or a colocation data center, may allocate such infrastructure from public cloud resources, or may perform a combination of the foregoing. In some examples, the user may pay for the computing solution on a usage, consumption, or subscription basis. The entity operating the cloud platform 102 may maintain some or all management responsibility over the computing solution (e.g., computing devices 108A-108N).

The cloud platform 102 provides service catalogs 112A and 1128 (described later) listing cloud services provided by service platforms 106A and 1068 that are available for the users of the cloud platform 102. The service catalogs 112A and 1128 may be presented as separate catalogs or as a combined catalog. The users of the cloud platform 102 can access the cloud services using their computing devices 108A-108N or via other devices not shown. The cloud platform 102 may manage the environment in each of the computing devices 108A-108N to allow users to interact and manage services provided by the service platforms 106A-106N.

The computing devices 108A-108N are devices on which the applications 110A-110N are developed and/or deployed. The users of the computing devices 108A-108N are registered with the cloud platform 102 and use the infrastructure and services provided by the cloud platform 102. Examples of the computing devices 108A-108N may include, but are not limited to, smartphone, tablet computer, smartwatch, notebook computer, desktop computer, workstation, or Internet of Things (IoT) appliance. In some examples, the computing devices 108A-108N may include a Virtual Machine (VM) running on the computing devices 108A-108N. Users of the computing devices 108A-108N may be developing applications 110A-110N that are to be deployed. The applications 110A-110N may refer to a program or a group of programs designed to perform a function or a group of coordinated functions for a user.

In an example, the application 110A may be a web application, which may be stored on a server and delivered over the Internet to a user through a web browser. The application 110A may have to perform several functions. For instance, a web application may have to store content in a database, receive a request for the content from the user, retrieve the content from the database, and present the content to the web browser. The database may be, for example, a database managed using a relational database management system (RDBMS) that uses Structured Query Language (SQL). Further, the receipt of the request, retrieval of the content, and presentation of the content may be performed using a hypertext pre-processor (PHP) language, which is a server-side scripting language for creating dynamic web pages.

In some cases, some of the functions of the application 110A may be performed by services provided by service platforms 106A-106N. The developers of the application 110A-110N at the computing devices 108A-108N may select the services via the service catalogs 112A and 112B provided by the cloud platform 102. For instance, referring to the example of web application discussed above, the database and a PHP service (a service that receives the request, retrieves content, and presents the content using the PHP language) may each be provided as a service external to the application 110A. Accordingly, a first service may be a database service provided by a service platform 106A and a second service may be a PHP service provided by a service platform 106B. On provisioning of the service instance by the service platforms 106A-106N, the applications 110A-110N may bind themselves to the service instance to make use of the service.

The service platforms 106A-106N may offer services provided by vendors to users (i.e., customers) of the cloud platform 102. Relative to the cloud platform 102 and the operator or provider thereof, the vendors may be first-party vendors or third-party vendors that are providing services in the cloud platform 102. The services may include, but are not limited to software as a service (SaaS) by hosting applications, infrastructure as service (IaaS) by hosting equipment (servers, storage components, network components, etc.), a platform as a service (PaaS), and/or other services. The IaaS vendors offer the capability to provision processing, storage, networks, and other basic computing resources. PaaS vendors offer computing platforms in the form of operating systems, execution runtimes, databases, and webservers. The SaaS vendors offer software applications as a subscription service that are generally accessible from web browsers or other thin-client interfaces, and users do not load the applications on the local computing devices. In some examples, the service platforms 106A-106N may include public cloud providers. In some examples, the service platforms 106A-106N may build, own, and/or run services on respective platforms (e.g., managed services). The managed services running on their platforms are provided as services to the cloud platform 102. In some cases, the service platforms 106A-106N may provide cloud services for execution on the cloud platform 102 by exposing native APIs. In some examples, the native APIs may include REST APIs. The native APIs allow users to build applications.

In some examples, the cloud platform 102 may include service catalogs 112A and 1128 and the centralized API broker 104. The centralized API broker 104 provides the service catalogs 112A and 1128 to the cloud platform 102. The service catalogs 112A and 1128 expose the services provided by the service platform 106A and 106B to users of the cloud platform 102 for developing their applications 110A-110N. In some examples, the centralized API broker 104 may act as a common service broker that communicates with multiple vendors and registers the services provided by the service platforms 106A-106N.

In some examples, the service platforms 106A-106N may be registered at the centralized API broker 104 with a vendor identity. The service platforms 106A-106N may upload their service in the form of multiple REST APIs to the centralized API broker 104. The multiple REST APIs may be associated with different lifecycle actions of the service. For example, a first REST API may be associated with a lifecycle action of listing the services (different configuration options), a second REST API is associated with a lifecycle action of provisioning the service, and so on. In some examples, the lifecycle actions associated with the service may include, but are not limited to, listing the services provided by the service platform, creating a service instance, updating the service instance, binding the service instance, and deleting the service instance.

The centralized API broker 104 converts the uploaded REST APIs of the service platforms 106A-106N to first APIs that are compliant with the API specification supported by the cloud platform 102 using mapping information in a database 120. As used herein, the term “API specification” refers to an API description language or syntax used for describing the resources provided by the service platforms 106A-106N and general information related to the API.

In some examples, the centralized API broker 104 stores the vendor identity and mapping information of the registered service platforms 106A-106N. Each vendor, while registering their services, may provide mapping information. In some examples, the mapping information may include a vendor-specific command mapping and a vendor-specific parameter mapping. In addition to the vendor identity and mapping information, the database 120 may store the REST APIs provided by the vendors of the service platforms 106A-106N. In some examples, the database 120 may be dynamically updated by the vendors of the service platforms 106A-106N.

In some examples, the centralized API broker 104 may be implemented as software (e.g., a set of executable instructions) that is executable by a processor 114. The processor 114 may execute the set of instructions stored in a non-transitory machine-readable medium 116. The processor 114 may be implemented as one or more microprocessors, microcomputers, microcontrollers, digital signal processors, central processing units, state machines, logic circuitries and/or any devices that manipulate signals based on operational instructions. The machine-readable medium 116 may include any non-transitory computer-readable medium including, for example, volatile memory (e.g., RAM), and/or non-volatile memory (e.g., EPROM, flash memory, a hard disk drive, etc.).

The processor 114 may be configured to execute instructions 118 (e.g., programming or software code) stored in the machine-readable medium 116 to perform the functions of the centralized API broker. 104. The instructions 118 are run to perform functions related to providing services from the service platforms 106A-106N to the computing devices 108A-108N. The instructions 118 when executed by the processor 114 causes the processor 114 to convert a first operation request into the second operation request. The first operation request is generated in response to the selection of a catalog item from the service catalogs 112A and 112B of the service platforms 106A-106N.

The service catalog 112A may be associated with the service provided by service platform 106A, and the service catalog 1128 may be associated with the service provided by the service platform 1068. The service catalogs 112A and 1128 may include a set of catalog items associated with a set of lifecycle actions associated with the service. As discussed above, the catalog items are associated with different lifecycle actions of the service. For example, a first catalog item may be associated with listing the services (with different configuration options) and the second catalog item may be associated with provisioning a service instance. Further, each of the catalog items may be associated with an API request that is compliant with the first API specification. Although FIG. 1 depicts that two service catalogs 112A and 112B corresponding to the services provided by service platforms 106A and 106B respectively, it should be understood that the cloud platform 102 may provide different numbers of service catalogs of one or more service platforms or a single combined service catalog.

During operation, if a user of a computing device (e.g., the computing device 108A) selects a catalog item from the service catalog 1128 for provisioning service, the service catalog 1128 may generate a first operation request. The user interacts with the service platform 1068 using a user interface provided by the cloud platform 102. The service catalog 1128 transmits a first operation request to the centralized API broker 104. The centralized API broker 104 converts the first operation request that is compliant with the first API specification used at the cloud platform 102 to a second operation request that is compliant with a second API specification supported by the service platform 106B.

In some examples, a first command in the first operation request that is compliant with the first specification of the cloud platform 102 may be mapped to a second command that is compliant with the second API specification supported by the service platform 106B. The first command and the second command are indicative of the same operation (i.e., the lifecycle action) requested by the user. In an example, the first command may be compliant with the OSB API specification supported by the cloud platform 102 and the second command may be compliant with a native API specification supported by the service platform 106B. In an example, the first operation request may be a provisioning API request (e.g., a PUT /v2/service instances/:instance_id) that is compliant with the OSB API specification supported by the cloud platform 102. The centralized API broker 104 identifies the first command as a “PUT” command in the first operation request and determines a second command associated with the vendor using the vendor-specific command mapping. The second command may be a “POST” command as per the vendor-specific command mapping. Once the second command is identified, the centralized API broker 104 converts the first operation request into a second operation request.

The centralized API broker 104 converts the first operation request to the second operation request by identifying a template corresponding to the second command. The centralized API broker 104 uses the template with the second command for generating the second operation request. The template may be associated with the lifecycle action and may include the corresponding second command. In the example discussed above, the template includes the command “POST” and the second operation request may be a provisioning API request (e.g., curl-X POST http://{{URL}}/apps-H ‘Content-Type: application/json) that is compliant with a native API specification supported by the service platform 106B.

The template is populated based on data present in the first set of parameters in the first operation request and the mapping between the first set of parameters and the second set of parameters as provided by the vendor-specific parameter mapping. The vendor-specific parameter mapping is provided by the vendor during registration of the service at the centralized API broker 104 and provides a mapping between the first set of parameters and the second set of parameters. The registration may be a part of or a prerequisite to the process of publishing a cloud service and lifecycle actions thereof to a service catalog 112A or service catalog 1128. During registration, the vendors provide the mapping information for converting the first operation request to the second operation request.

The first set of parameters and the second set of parameters refer to fields in an API request that are associated with the service and identification information of the requestor (i.e. the cloud platform 102). The fields related to the API request may be provided in a mark-up language format, such as JavaScript® Object Notation (JSON) format or YAML Ain′t Markup Language (YAML) format.

Examples of the first set of parameters and the second set of parameters may include, an identity of the cloud platform 102 (cloud ID), a uniform resource locator (URL) of the service, a service instance ID (service identity), name of the service, metadata, label (i.e. a tag) with additional instruction, and the plan (plan identity) selected by the user of the cloud platform 102. For example, a plan as per the first API specification of the cloud platform 102 may be mapped to a version in the second API specification of the service platform.

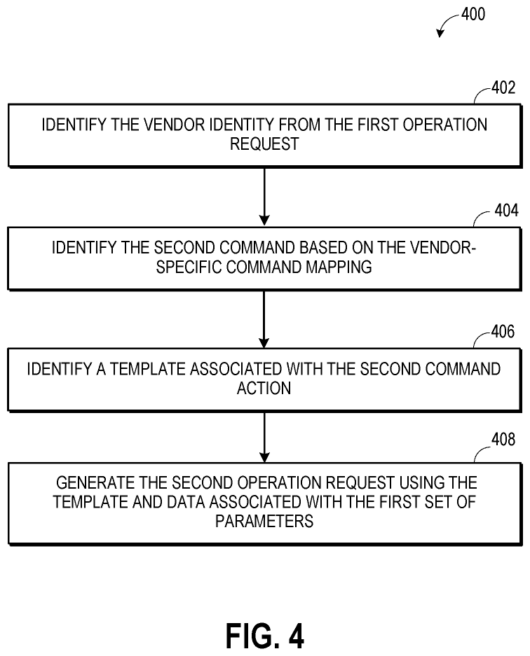

In some examples, the first operation request is a first API that is converted into a REST API (i.e., the second operation request) that is compliant with the second API specification of the service platform 1068. Once the second operation request is generated, the centralized API broker 104 makes an API call requesting the service platform 106B to perform the requested lifecycle action. Additional details regarding the generation of the second operation request will be described in conjunction with the example illustrated in FIG. 4.

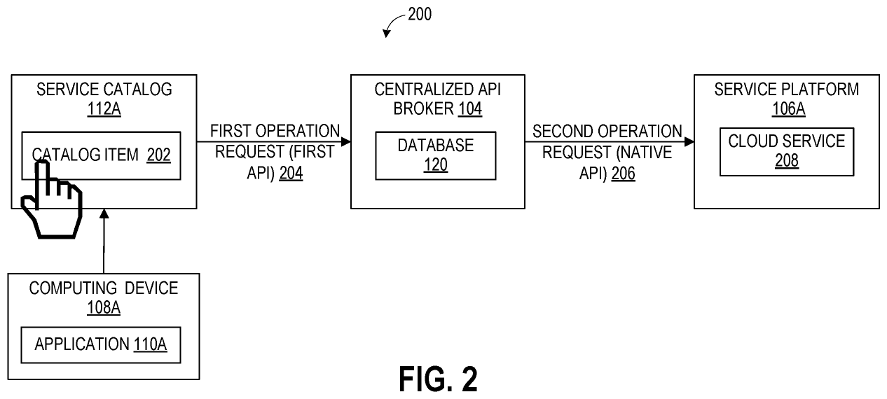

FIG. 2 illustrates an example of a block diagram 200 depicting interaction between various elements for providing services. In an example, a user of the computing device 108A may require a cloud service 208 for the application 110A. The cloud service 208 may be provided by service platform 106A. The different lifecycle actions of the service offered by the service platform 106A are listed as catalog items. The interactions between the users of the computing device 108A and the service platform 106A occur via the catalog items in the service catalog 112A. For example, a catalog item 202 may be associated with provisioning (i.e., a lifecycle action) of the service provided by the service platform 106A.

The user of the computing device 108A may select the catalog item 202 in the service catalog 112A for utilizing the service provided by the service platform 106A. The catalog item 202 may be associated with a configuration of the service (e.g., a plan). The service platform 106A may provide multiple variants of service in the form of different plans. For example, the different plans may represent the cost and size (small, medium, large) of a cloud service 208 offered. The selection of the catalog item 202 results in the generation of a first operation request 204. In some cases, the user may be provided with options to select/add any additional parameters. In an example, the first operation request 204 may be a first API for provisioning the service provided by the service platform 106A.

The centralized API broker 104 receives the first operation request 204 via the service catalog 112A. In FIG. 2, the service catalog 112A transmits the first operation request according to the first API to the centralized API broker 104. On receiving the first operation request 204, the centralized API broker 104 determines the vendor identity from the API request and converts the first operation request 204 into a second operation request 206. The conversion may be performed based on mapping information stored in the database 120. The conversion is performed based on a mapping between a first command specific to the first API specification and a second command specific to the second API specification according to the vendor-specific command mapping provided by the vendor.

In an example, the first operation request 204 may be a provisioning API request (e.g., a PUT /v2/service instances/:instance_id) that is compliant with the OSB API specification supported by the cloud platform 102. The second operation request 206 may be a provisioning API request (e.g., curl-X POST http://{{URL}}/apps-H ‘Content-Type: application/json) that is compliant with a native API specification supported by (e.g., native to) the service platform 106A. The centralized API broker 104 makes an API call using the second operation request 206 to the service platform 106A to provision the service. The service platform 106A generates a service instance as per data associated with the second set of parameters in the second operation request 206. Once the service instance is generated for utilizing a cloud service 208, the centralized API broker 104 binds the service instance using credentials associated with the service platform 106A to the application 110A for using the cloud service 208.

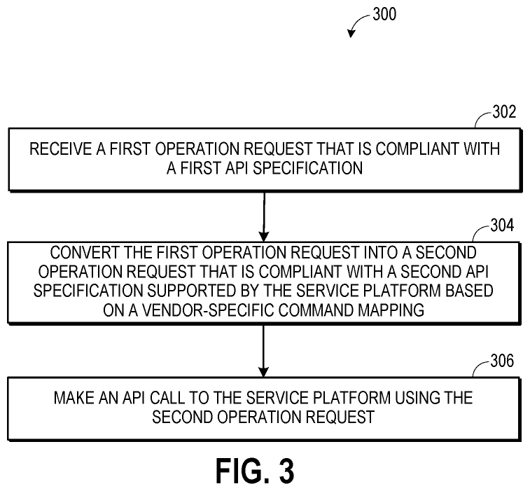

FIG. 3 is a flow diagram of an example method 300 for providing services offered by a service platform using the centralized API broker 104 of FIG. 1. The method 300 depicted in FIG. 3 may be implemented in the form of executable instructions stored on a machine-readable medium and executed by a processing resource. For example, method 300 may be performed by the centralized API broker 104 of FIG. 1 for providing services offered by service platform 1068. FIG. 3 will be explained in conjunction with FIG. 1.

At block 302, the centralized API broker 104 receives a first operation request that is compliant with the first API specification. The first operation request may include a first API associated with a catalog item selected by the user of the computing device 1088 for the application 1108. In an example, the first operation request may be directed to a lifecycle action of a service (e.g., binding of the service instance to an application 1108) supported by the service platform 1068.

At block 304, the centralized API broker 104 converts the first operation request into a second operation request using the vendor-specific command mapping.

TABLE 1
Example vendor-specific command mapping for service platform 106B
Vendor ID -UUID

| First Command | Second Command |
|---|---|
| (Cloud platform) | (Service platform) |
| GET | GET |
| PUT service instance | POST Items |
| PUT binding | Get Endpoint |
| DELETE | DELETE |

In some examples, the vendors of the service platforms 106A-106B provide the vendor-specific command mapping table to the centralized API broker 104 during registration of the service platforms 106A-106B. The vendor is registered at the centralized API broker 104 using a vendor identity. The mapping information provided by the vendor may be stored in the database 120 with a unique vendor identity. Further, the vendor may also provide a template for generating the second operation request. The centralized API broker 104 uses the template provided by the vendor for generating the second operation request. The first set of parameters are translated to the second set of parameters based on the vendor-specific parameter mapping. The second set of parameters in the template is derived from the data associated with the first set of parameters. Additional details related to the template and generation of the second request are described in FIG. 4.

At block 306, the centralized API broker 104 makes an API call to the service platform 106B using the second operation request. In some examples, the second operation request generated at the centralized API broker 104 is transmitted from the cloud platform 102 to the service platform 1068 over the network. In some examples, in the case where the second operation request is a provisioning API request, the service platform 106B uses the service instance to provide the requested service.

FIG. 4 is a flow diagram of an example method 400 for converting the first operation request to the second operation request. The method 400 depicted in FIG. 4 may be implemented in the form of executable instructions stored on a machine-readable medium and executed by a processing resource. For example, method 400 may be performed by the centralized API broker 104 of FIG. 1. FIG. 4 will be explained in conjunction with FIGS. 1 and 3.

At block 402, the centralized API broker 104 identifies the vendor identity present in the first operation request. The first operation request may also include a first set of parameters in the body of the request. The service catalogs 112A and 1128 are provided by vendors of the service platforms 106A and 1068 respectively and each catalog item in the service catalogs 112A and 1128 is associated with the respective vendor identity. The vendor identity allows the centralized API broker 104 to manage the provisioning, and lifecycle of the services provided by multiple service platforms.

At block 404, the centralized API broker 104 identifies a second command based on the vendor-specific command mapping in the database 120. To identify the second command, the centralized API broker 104 identifies the first command in the first operation request. The first command is associated with the lifecycle action of the service requested by the user and compliant with the first API specification. The centralized API broker 104 then identifies a second command using the vendor-specific command mapping stored at the database 120 of the centralized API broker 104 provided by the vendor for the service platform 106B. The second command is associated with the same lifecycle action of the service and is compliant with the second API specification supported by the service platform providing the service.

At block 406, the centralized API broker 104 identifies a template associated with the second command for generating the second operation request. The template includes a native API curl command (i.e., the second command) associated with the lifecycle action provided by the service platform 106B. The template includes the second set of parameters in the body of the template. In some examples, the native API curl command may be compliant with the second API specification supported by the service platform 106B. In some examples, the API curl command may be a network request that is sent to a specified URL.

At block 408, the centralized API broker 104 generates the second operation request using the template, and data associated with the first set of parameters. The centralized API broker 104 uses the vendor-specific parameter mapping to determine the second set of parameters corresponding to the first set of parameters. In some examples, the vendor-specific parameter mapping may be present in the form of a table including a mapping between the first set of parameters present in the first operation request and the corresponding second set of parameters used in the second operation request that is compliant with the API specification of the service platform. The vendor-specific parameter mapping may be a combination of mappings that are generally applicable to some or all service platforms and additional mappings that are specific to the vendor of the service platform. The centralized API broker 104 translates the first set of parameters in the first operation request to the second set of parameters in the template using vendor-specific parameter mapping stored in the database 120. The centralized API broker 104 derives the second set of parameters in the template from the data associated with the first set of parameters generate the second operation request.

The second operation request includes a link (i.e., a URL) to the requested service provided by the service platform. The centralized API broker 104 makes an API call using the generated second operation request to the computing resource provided by the service platform 106B. Consider an example, when a user of the first computing device 108A selects a catalog item from service catalog 1128 related to the provisioning of a service provided by service platform 1068. On selection, a first operation request for provisioning the service may be received at the centralized API broker 104. The first operation request may be a first API generated by the cloud platform 102 and may be a file in JSON format. An example of the first operation request is shown below.

```
PUT /v2/service_instances/:instance_id
  {
    “services”: [{
    “name”: “wordpress”,
    “id”: “1b6ae956-22b5-11e8-b70a-0242ac130002”,
      “plans”: [{
        “name”: “0.6.0”,
        “ instance id”:
        “d3031751-XXXX-XXXX-XXXX-a42377d3320e”,
        “description”: “WordPress is one of the most versatile open
source content management systems on the market. A publishing platform
for building blogs and websites.”,
        “free”: false,
        “metadata”: {
        },
```

In the above first operation request, the first set of parameters are shown. The first set of parameters may include a cloud identity, a service instance ID, a version (i.e., a configuration) for the service selected by the user, the name of the service, description of the service, and other metadata associated with the service. The PUT command in the first operation request (i.e., the first API) may be associated with the provisioning of the service for the cloud platform 102. The centralized API broker 104 may identify a PUT service instance command (i.e., the first command) in the first operation request and convert the PUT service instance command to the POST command (i.e., the second command) which is supported by the service platform 106B providing the service. The conversion is performed using the vendor-specific command mapping. The centralized API broker 104 uses a template with the POST command to generate the second operation request. An example of the template with the POST API curl command is shown below.

```
curl -X POST http://{{URL}}/apps -H ′Content-Type: application/json′
{
  ″cloudServiceId″: ″%s″,
  “instanceId”: “%s”
  ″version″: ″%s″,
  ″name″:″%s″,
  ″label”: “%s”
```

The centralized API broker 104 replaces the % s in the second set of parameters in the template with values from the corresponding first set of parameters translated via the vendor-specific parameter mapping to generate the native API request. The centralized API broker 104 then makes an API call according to the URL present in the native API request.

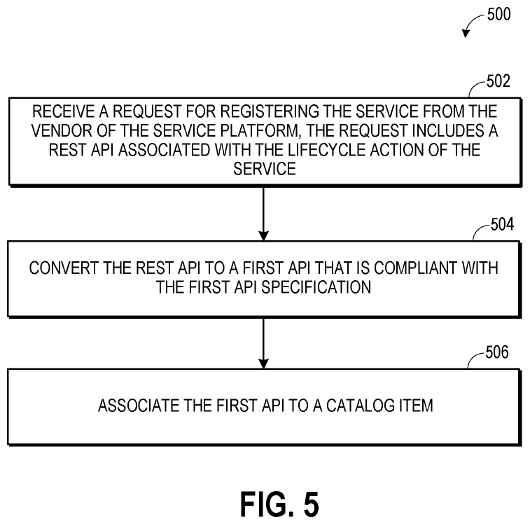

FIG. 5 is a flow diagram of an example method 500 for providing the service catalog 112A-112B with catalog items at the cloud platform 102. The centralized API broker 104 registers the vendor of the service platforms 106A-106N and the service offered (i.e., the native APIs). The method 500 depicted in FIG. 5 may be implemented in the form of executable instructions stored on a machine-readable medium, such as the machine-readable medium 116, and executed by a processing resource such as processor 114 of FIG. 1. For example, method 500 may be performed by the centralized API broker 104. FIG. 5 will be explained in conjunction with FIG. 1.

At block 502, the centralized API broker 104 receives a request for registering a service from the vendor of the service platform. The registration may be a part of or a prerequisite to the process of publishing a cloud service and lifecycle actions thereof to a service catalog 112A or 112B. In some examples, the request may be in the form of a native API, for example, a REST API associated with a lifecycle action of the service. The REST API may be uploaded by the vendor of the service platform using a Swagger specification. In some examples, the Swagger specification is associated with the OSB API specification. Each service may include multiple lifecycle actions associated with the service and the vendor may upload multiple REST APIs for performing different lifecycle actions used for managing the lifecycle of the service.

At block 504, the centralized API broker 104 converts the REST API to a first API that is compliant with the first API specification. When the API specification (e.g., the OSB API) supported by the cloud platform 102 and the service platform (e.g., the REST API) are different, the centralized API broker 104 converts the REST API into the first API that is compliant with the first API specification of the cloud platform 102.

At block 506, the centralized API broker 104 associates the first API to a catalog item. The catalog items allows the user to perform the lifecycle action. Multiple catalog items associated with different lifecycle actions allows the users to perform different operations.

In some cases, the vendor may provide the API curl command associated with the lifecycle action while uploading the REST API. The API curl command of the service platform may be translated to a first command using vendor specific-command mapping. The vendor may provide the mapping between the GET API curl command and the OSB GET V2/catalog while uploading the REST API. The first API may then be linked to a catalog item in the service catalog. For example, a GET API curl command (e.g., http://{{URL}}/apps-H ‘Content-Type: application/json’) may be mapped to an OSB GET V2/catalog.

In other cases, the API curl command may not be provided along with the REST API uploaded by the vendor. For example, the centralized API broker 104 may convert the uploaded REST API into Postman collections JSON using Newman cli. The centralized API broker 104 reads the JSON in the postman collections and determines the API curl command. The centralized API broker 104 may determine the API curl command (i.e., second command) of the service platform 106B and associate it with a command (i.e., first command) supported by the cloud platform 102 using the vendor-specific command mapping. The centralized API broker 104 translates the REST API of the service platform 106B to a first API that may be associated with the catalog item.

In some examples, for utilizing the services of the service platform 106B, the centralized API broker 104 provides the various lifecycle actions of the service in the form of catalog items in the service catalog 112B. When the user selects the catalog item, the centralized API broker 104 receives the first operation request and converts it to the second operation request. For examples, when a user may select a catalog item to receive a list of services offered by the service platform. The catalog item may be associated with an OSB GET V2/catalog command. The centralized API broker 104 translates the OBS GET V2/catalog command to the respective GET API curl command of the vendor using mapping information (i.e., the vendor-specific parameter mapping) provided by the vendor of the service platform for generating the second operation request.

In some examples, when there are changes in the services provided by the service platform 106A and 106B, the vendors may re-register their REST API using the method 500. The vendor may provide an additional REST API that is converted into an additional first API. In some cases, the additional REST API may be modified version of the previously received REST API. In some cases, the additional REST API may be an updated version of the previously received RST API The additional rest API is converted into additional first API. The catalog item is disassociated with the first API before associating the catalog item with the additional first API in the service catalog. This type of update of the first API in the service catalog is performed by the service platforms by re-uploading their REST APIs, unlike existing service catalogs in which teams of the cloud platform 102 track and update the service broker and corresponding end-points.

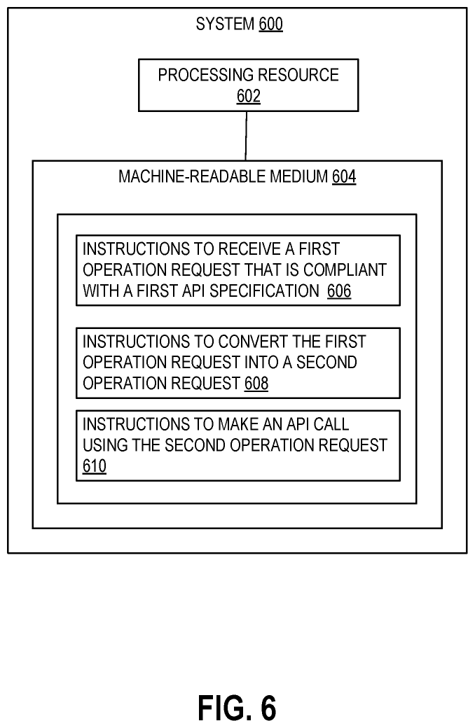

FIG. 6 is a block diagram of a system 600 for implementing a centralized API broker such as the centralized API broker 104 of FIG. 1. In some examples, the system 600 may have hardware including a processing resource 602 and a non-transitory machine-readable medium 604. The processing resource 602 and the machine-readable medium 604 may be similar to the processor 114 and the machine-readable medium 116 respectively, as described in FIG. 1. FIG. 6 will be explained in conjunction with FIG. 1. In some implementations, the centralized API broker 104 may be implemented by executing instructions of the machine-readable medium 604 on the processing resource 602. When implemented in this manner, the centralized API broker 104 may be executing on the system 600 as an application, in a virtual machine, as a container or container pod, etc.

The processing resource 602 may be one or more microprocessors, microcomputers, microcontrollers, digital signal processors, central processing units, state machines, logic circuitries, and/or any devices that manipulate signals based on operational instructions. Further, the machine-readable medium 604 is non-transitory and may be any electronic, magnetic, optical, or other physical storage devices that may store data and/or executable instructions. The machine-readable medium 604 may be encoded with executable instructions 606, 608, and 610 (hereinafter collectively referred to as instructions 606-610) for providing services offered by service platforms 106A-106N to users of computing devices 108A-108N.

The processing resource 602 may be coupled to the machine-readable medium 604. The processing resource 602 may be configured to execute instructions 606-610 (i.e., programming or software code) stored in the machine-readable medium 604 for providing the services offered by services platforms 106A-106N to users of computing devices 108A-108N. In certain examples, as an alternative or in addition to retrieving and executing the instructions 606-610, the processing resource 602 may include at least one integrated circuit, other control logic, other electronic circuits, or combinations thereof that include a number of electronic components for performing the functionalities intended to be performed by the centralized API broker 104.

In an example, the instructions 606, when executed by the processing resource 602, cause the processing resource 602 to receive a first operation request at the centralized API broker 104. In an example, the first operation request may be a first API associated with the catalog item selected by the user of the computing device 108B. Further, the instructions 608, when executed by the processing resource 602, cause the processing resource 602 to convert the first operation request to the second operation request using the vendor-specific command mapping stored at the database 120. Furthermore, the instructions 610, when executed by the processing resource 602, cause the processing resource 602 to make an API call to the service platform 106B using the URL present in the second operation request. The processing resource 602 makes a call to the service platform 1068.

While certain implementations have been shown and described above, various changes in form and details may be made. For example, some features that have been described in relation to one implementation and/or process can be related to other implementations. In other words, processes, features, components, and/or properties described in relation to one implementation can be useful in other implementations. Furthermore, it should be appreciated that the systems and methods described herein can include various combinations and/or sub-combinations of the components and/or features of the different implementations described. Thus, features described with reference to one or more implementations can be combined with other implementations described herein.

We claim:

1. A method comprising:
receiving, by a processor-based centralized Application Programming Interface (API) broker, a first operation request that is compliant with a first API specification, wherein the first operation request is directed to a lifecycle action for a service provided by a service platform that is associated with a vendor;
converting, by the centralized API broker, the first operation request into a second operation request that is compliant with a second API specification supported by the service platform, wherein the converting is based on a vendor-specific command mapping between a first command specific to the first API specification and a second command specific to the second API specification; and
making, by the centralized API broker, an API call to the service platform using the second operation request.

2. The method of claim 1, further comprising associating, by the centralized API broker, a catalog item to the service, wherein the catalog item exposes the lifecycle action to users of a cloud platform.

3. The method of claim 1, wherein a plurality of vendors are registered with the centralized API broker, wherein the plurality of vendors provide services using respective service platforms, and wherein the vendor is among the plurality of vendors.

4. The method of claim 1, further comprising receiving, by the centralized API broker, the vendor-specific command mapping from the vendor, wherein the vendor-specific command mapping comprises an association between commands in the first API specification and corresponding commands in the second API specification.

5. The method of claim 4, wherein converting the first operation request to the second operation request further comprises:
identifying, by the centralized API broker, a template associated with the second command, wherein the template comprises the second command; and
generating the second operation request using the template and data associated with a first set of parameters of the first operation request, wherein the centralized API broker generates the second operation request based on a vendor-specific parameter mapping between the first set of parameters specific to the first API specification and a second set of parameters specific to the second API specification.

6. The method of claim 5, wherein the first set of parameters and the second set of parameters include fields corresponding to an ID, a plan, a name, a uniform resource locator (URL), metadata, a label, a service identity, or a plan identity.

7. The method of claim 1, further comprising:
receiving, by the centralized API broker, a request for registering the service from the vendor of the service platform, wherein the request comprises a Representational State Transfer (REST) API associated with the lifecycle action of the service;
converting, by the centralized API broker the REST API into a first API that is compliant with the first API specification; and
associating, by the centralized API broker, the first API to a catalog item, wherein the centralized API broker receives the first operation request based on a selection of the catalog item, wherein the first operation request comprises of the first API.

8. The method of claim 7, further comprising:
receiving, by the centralized API broker, a request for re-registering the service from the vendor of the service platform, wherein the request for re-registering comprises an additional REST API associated with the lifecycle action of the service;
converting, by the centralized API broker the additional REST API into an additional first API; and
associating, by the centralized API broker, the catalog item with the additional first API.

9. A system comprising:
a processing resource; and
a non-transitory machine-readable medium storing instructions that, when executed by the processing resource, causes the processing resource to:
receive a first operation request that is compliant with a first Application Programming Interface (API) specification, the first operation request is directed to a lifecycle action of a service provided by a service platform that is associated with a vendor;
convert the first operation request into a second operation request that is compliant with a second API specification supported by the service platform, wherein converting is based on a vendor-specific command mapping between a first command specific to the first API specification and a second command specific to the second API specification; and
make an API call to the service platform using the second operation request.

10. The system of claim 9, wherein the instructions when executed by the processing resource further cause the processing resource to associate a catalog item corresponding to the service, and wherein the catalog item exposes the lifecycle action to users of a cloud platform.

11. The system of claim 9, wherein a plurality of vendors are registered with a centralized API broker, wherein the plurality of vendors provide services using respective service platforms, and wherein the vendor is among the plurality of vendors.

12. The system of claim 9, wherein the instructions to convert the first operation request to the second operation request further causes the processing resource to:
receive the vendor-specific command mapping from the vendor, wherein the vendor-specific command mapping comprises an association between commands in the first API specification and corresponding commands in the second API specification.

13. The system of claim 12, wherein the instructions further cause the processing resource to:
identify a template associated with the second command, wherein the template comprises the second command; and
generate the second operation request using the template and data associated with a first set of parameters of the first operation request, wherein the processing resource generates second operation request based on a vendor-specific parameter mapping between the first set of parameters specific to the first API specification and a second set of parameters specific to the second API specification.

14. The system of claim 13, wherein the first set of parameters and the second set of parameters includes fields corresponding to an ID, a plan, a name, a uniform resource locator (URL), metadata, a label, a service identity, or a plan identity.

15. The system of claim 13, wherein the instructions further cause the processing resource to:
receive a request for registering the service from the vendor of the service platform, wherein the request comprises a Representational State Transfer (REST) API associated with the lifecycle action of the service;
convert the REST API into a first API that is compliant with the first API specification; and
associate the first API to a catalog item.

16. The system of claim 15, wherein the instructions further cause the processing resource to:
receive a request for re-registering the service from the vendor of the service platform, wherein the request for re-registering comprises an additional REST API associated with the lifecycle action of the service;
convert the additional REST API into an additional first API that is compliant with the first API specification; and
associate, the catalog item with the additional first API.

17. A non-transitory machine-readable medium comprising instructions executable by a processing resource, the instructions comprising:
instructions to receive a first operation request that is compliant with a first API specification, wherein the first operation request is directed to a lifecycle action for a service provided by a service platform that is associated with a vendor;
instructions to convert the first operation request into a second operation request that is compliant with a second API specification supported by the service platform, wherein the conversion is based on a vendor-specific command mapping between a first command specific to the first API specification and a second command specific to the second API specification; and
instructions to make an API call to the service platform using the second operation request.

18. The non-transitory machine-readable medium of claim 17, wherein converting the first operation request comprises of additional instructions that are executable by the processing resource, the instructions comprising:
instructions to identify a template associated with the second command, wherein the template comprises the second command; and
instructions to generate the second operation request using the template and data associated with a first set of parameters of the first operation request, wherein the second operation request is generated based on a vendor-specific parameter mapping between the first set of parameters specific to the first API specification and a second set of parameters specific to the second API specification.

19. The non-transitory machine-readable medium of claim 17, wherein a catalog item is associated with the service, and wherein the catalog item exposes the lifecycle action to users of a cloud platform.

20. The non-transitory machine-readable medium of claim 17, wherein a plurality of vendors are registered with a centralized API broker, wherein the plurality of vendors provide services using respective service platforms, and wherein the vendor is among the plurality of vendors.
